(19) United States
(12) Patent Application Publication
(10) Pub. No.: US 2024/0328223 A1
(43) Pub. Date: Oct. 3, 2024

(54) HIDDEN HINGE SYSTEM FOR DOORS OR WINDOWS

(71) Applicant: MASTERLAB S.R.L., Conversano (BA) (IT)

(72) Inventor: Michele Loperfido, Castellana Grotte (BA) (IT)

(21) Appl. No.: 18/580,756

(22) PCT Filed: Jul. 19, 2022
(86) PCT No.: PCT/IB2022/056636

§ 371 Date: Jan. 19, 2024

(30) Foreign Application Priority Data
Jul. 20, 2021 (IT) 102021000019220

(51) Int. Cl. E05D 15/30; E05D 3/18; E05D 11/06

(52) U.S. Cl. CPC E05D 15/30; E05D 3/18; E05D 11/06; E05Y 2600/41; E05Y 2900/132; E05Y 2900/148

(57) ABSTRACT

A hidden hinge system (1) for doors or windows comprising a fixed frame (100) defining an opening and a movable leaf (200) closing said opening, each of which is formed by profiles (101, 201) having at least one perimeter channel (102, 202), the hinge system comprising: a first body (2) that can be fixedly connected in a perimeter channel (102) of a profile (101) of the fixed frame (100); a second body (3) that can be fixedly connected in a perimeter channel (202) of a profile (201) of the movable leaf (200); and a lever assembly (4) articulating each other the first body (2) and the second body (3); the lever assembly (4) comprises, in turn, a first lever (5,) with a first end (5a) rotatably articulated to the first body (2) about a first rotation axis (A1) fixed with respect to the first body (2), a second end (5b) rotatably articulated to the second body (3) about a second rotation axis (A2) fixed with respect to the second body (3), and a middle portion (5c) interposed between its first end (5a) and its second end (5b), a second lever (6) having a first end (6a) articulated to the first body (2), a second end (6b) rotatably articulated to one end of the second body (3) about a third rotation axis (A3) and a middle portion (6c) interposed between its first end (6a) and its second end (6b), the first lever (5) and the second lever (6) being rotatably articulated each other in correspondence of their middle portion (5c, 6c) about a fourth rotation axis (A4); the second, third and fourth rotation axes are parallel with respect to the first rotation axis (A1); wherein the first end (6a) of the second lever (6) is articulated to the first body (2) by a kinematic pair (7, 8) realizing a rotation and translation relative motion of the first with respect to the second respectively about a fifth rotation axis (A5) parallel with respect to the first rotation axis (A1) and along a trajectory (T) that extends towards the first rotation axis A1 and that for at least a section is tangent or coincident with respect to at least a rectilinear direction (R) contained in a plane perpendicular with respect to the first rotation axis (A1), wherein said at least one rectilinear direction (R) is incident with respect to the plane defined by the opening (PA).

The present invention relates to a hinge system of the so-called “hidden” type for connecting a fixed frame to a movable leaf of a door or window and which allows to reach an opening angle of the movable leaf with respect to the fixed frame of a maximum amplitude of 180°. Various hinge systems are currently known for leaves of doors or windows of homes, offices or industrial sheds, which cause the leaf during opening and closing movements not only to rotate with respect to the fixed frame of the door or window, but also to move perpendicularly to the plane in which the fixed frame lies, moving closer and away from it.

Examples of such hinge systems are described in EP1830024 and EP1918498.

In particular, hidden hinge systems that allow to reach an opening angle of the movable leaf with respect to the fixed frame of maximum amplitude of 180° are already known.

Examples of such hidden hinge systems are for instance known from EP3256676 (GSG), EP3322873 (Fapim), EP2811092 (Schuco), EP2708692 (WSS WILH SCHLECHTENDAHL & SOEHNE GMBH & CO KG) or in patents IT1406348 and IT102017000126014 (EP3480398) in the name of the same owner.

All these hinge systems have in common that they comprise a first body which is fixed in a perimeter channel of a profile of the fixed frame, a second body which is fixed in a perimeter channel of a corresponding profile of the movable leaf, and a lever assembly articulating each other the first body and the second body, so that the latter performs a roto-translational motion during the opening and the closing of the movable leaf with respect to the fixed frame with a motion component perpendicular with respect to the plane defined by the opening (gap) delimited by the fixed frame itself.

The lever assembly generally comprises at least two levers, a first lever and a second lever, which are hinged to each other “scissor-like” in correspondence of a middle portion thereof and whose opposite ends are articulated respectively to the first body and to the second body rotatably with respect to corresponding rotation axes, wherein at least one of the opposite ends of these two levers is provided with a further motion component relative to the first body or second body.

In the system known from EP3256676 (GSG), for example, an end of one of these two levers is rotatable about a pin that is slidably inserted into a slot obtained in the first body (i.e. the one fixed to the frame), wherein said slot has straight development extending along the longitudinal development of the first body parallel with respect to the plane of the leaf.

In such a solution, when the movable leaf opens, the opening delimited by the fixed frame is at least partially reduced by the size of the leaf itself.

The hinge systems known from EP3322873 (Fapim) and EP2811092 (Schuco), wherein one end of the two levers, in addition to being rotatable with respect to a corresponding rotation axis, is made to rotate through an arc of circumference by means of a connecting rod component, solve at least in part such a drawback.

In all known solutions, however, when the movable leaf is fully open (180°), it is leaning against the fixed frame or the wall, with consequent relative difficulties both in assembly/disassembly and in use, making it difficult, for example, to open it safely. Moreover, such a reduced distance does not allow the installation of additional support systems, also of the “hidden” type, acting between the fixed frame and the movable leaf and useful for increasing the load-bearing capacity of the hinge system, particularly for opening angles equal to or greater than 90°.

Therefore, it is an object of the present invention to provide a hidden hinge system that makes it possible to overcome the drawbacks of the prior art.

An object of the present invention is to provide a hidden hinge system that allows a movable leaf to be opened with respect to a fixed frame until reaching a maximum opening angle equal to 180°, leaving the opening (gap) delimited by the fixed frame completely free.

Another object of the present invention is to provide a hidden hinge system that allows to open a movable leaf with respect to a fixed frame until reaching a maximum opening angle equal to 180°, keeping the movable leaf at a desired distance from the fixed frame.

A further object of the present invention is to provide a hidden hinge system that makes it possible to simplify the assembly and disassembly operations of the movable leaf, in any case ensuring its support in any opening condition, even against the risks of detachment and without the use of additional elements of temporary connection thereof or parts thereof to the profiles of the frame and/or of the leaf.

Still another object of the present invention is to provide a hidden hinge system that allows to open a movable leaf with respect to a fixed frame until reaching a maximum opening angle equal to 180°, being in any case able to easily and safely adjust the maximum amplitude of the opening angle according to the different assembly and installation needs.

These and other objects of the present invention are achieved with a hidden hinge system for doors or windows having the features according to claim 1. Further features are specified in the dependent claims. These and other advantages of the present invention will become more apparent to the person skilled in the art from the following detailed description of some exemplary and non-limiting embodiments, illustrated with reference to the following figures:

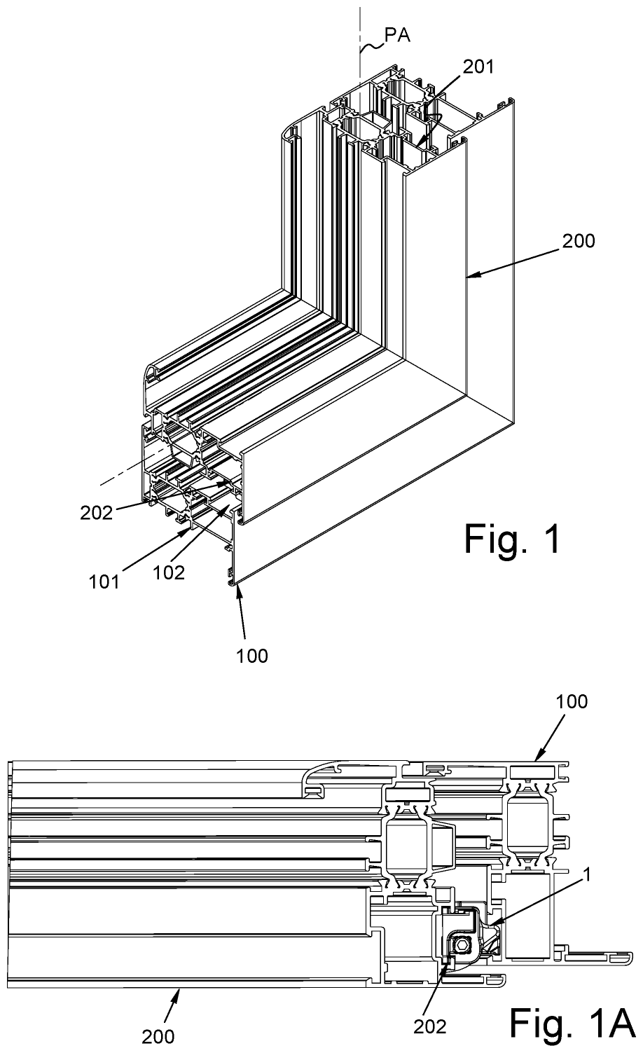

FIG. 1 shows in axonometry a portion of a fixed frame and of a movable leaf connected by means of a hidden hinge system according to the present invention;

FIG. 1A is a plan view of FIG. 1;

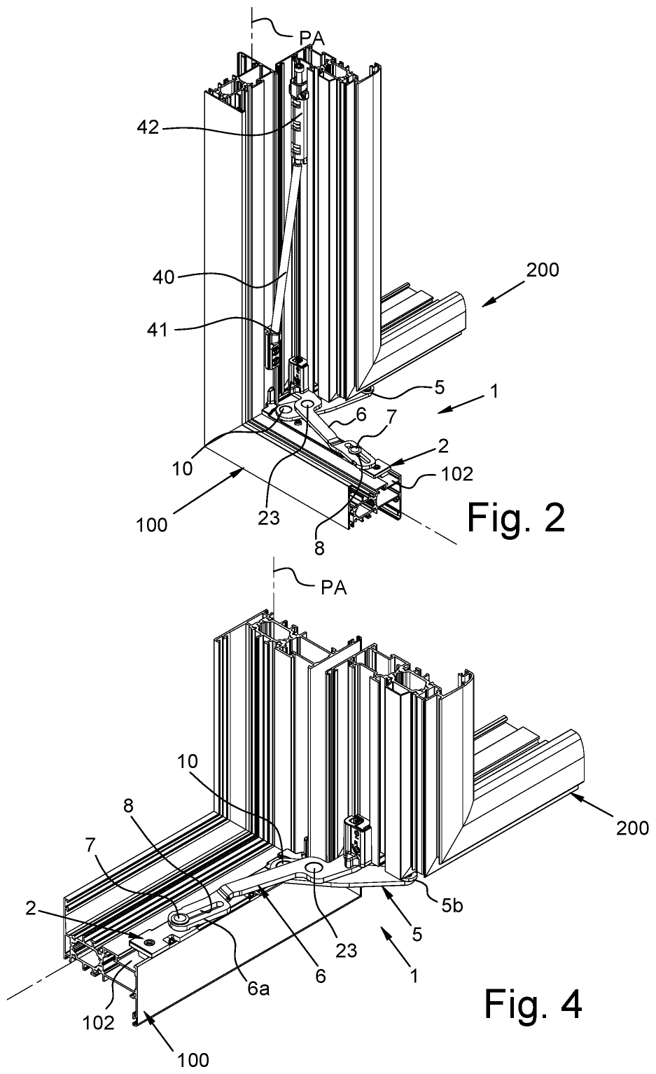

FIGS. 2, 3 and 4 are figures similar to FIG. 1 in different opening positions of the movable leaf with respect to the fixed frame, wherein in FIG. 2 there is also an additional support system of the movable leaf with respect to the fixed frame;

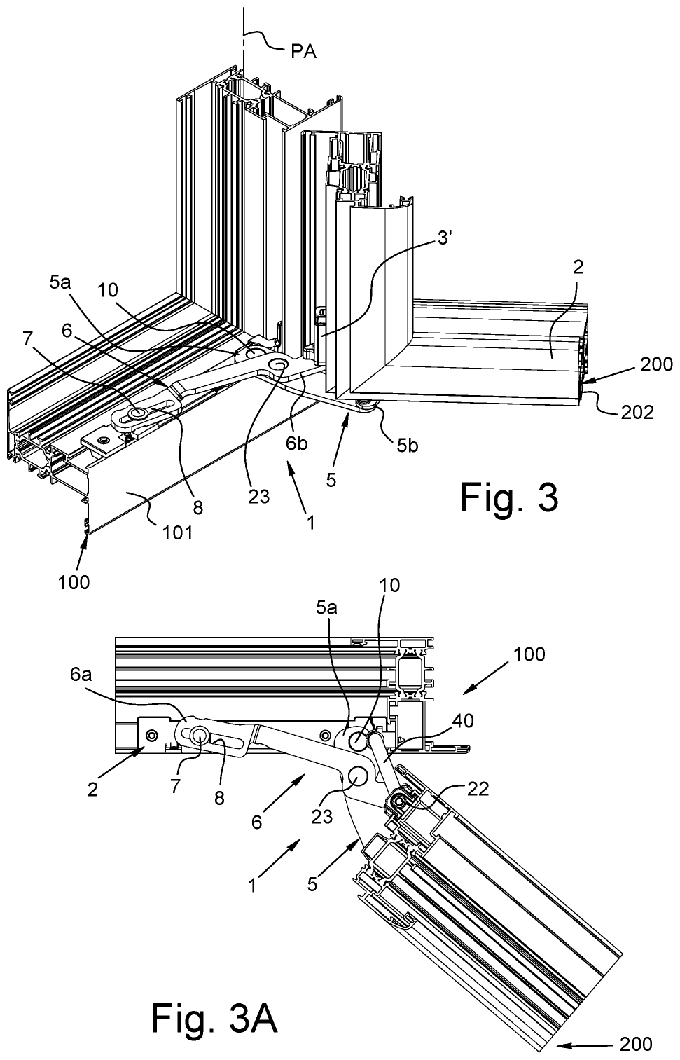

FIG. 3A is a plan view from above of FIG. 3, wherein an additional support system of the movable leaf with respect to the fixed frame is also present between the movable leaf and the fixed frame;

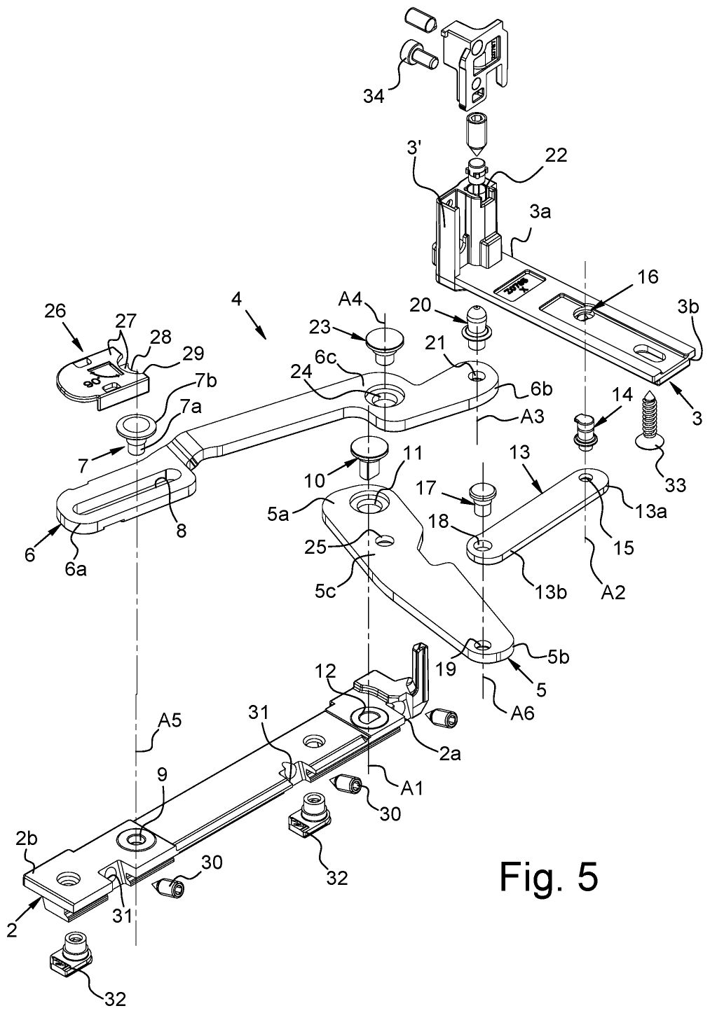

FIG. 5 is an axonometric and exploded view of the hidden hinge system according to the present invention;

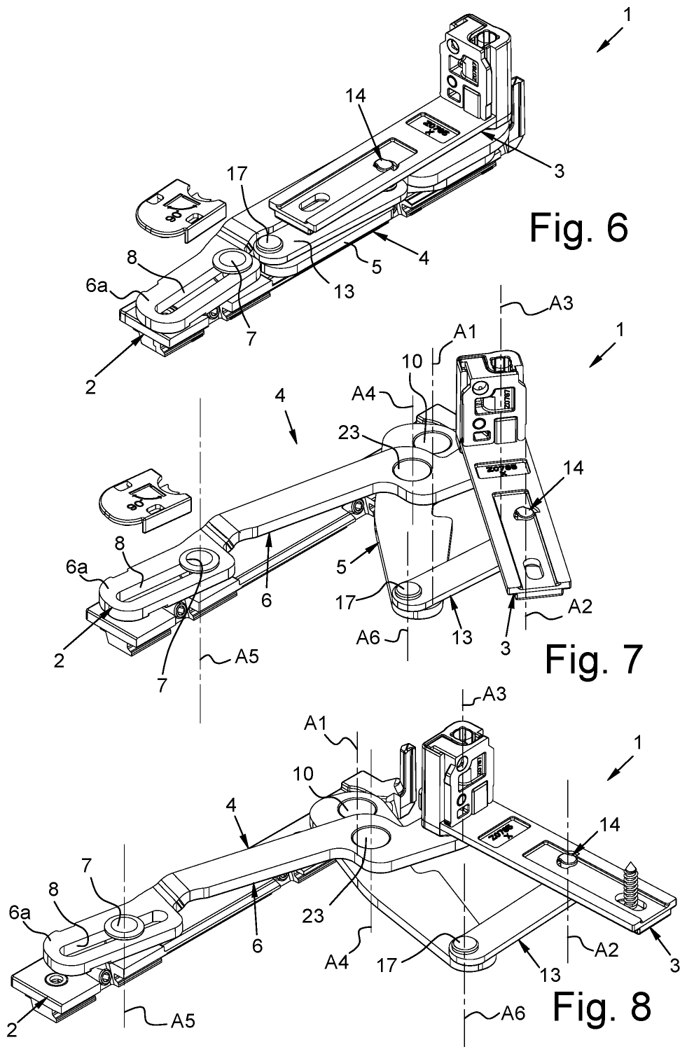

FIGS. 6, 7 and 8 show in axonometry the hinge system of FIG. 5 assembled in the closed, partially open and 90° open position respectively,

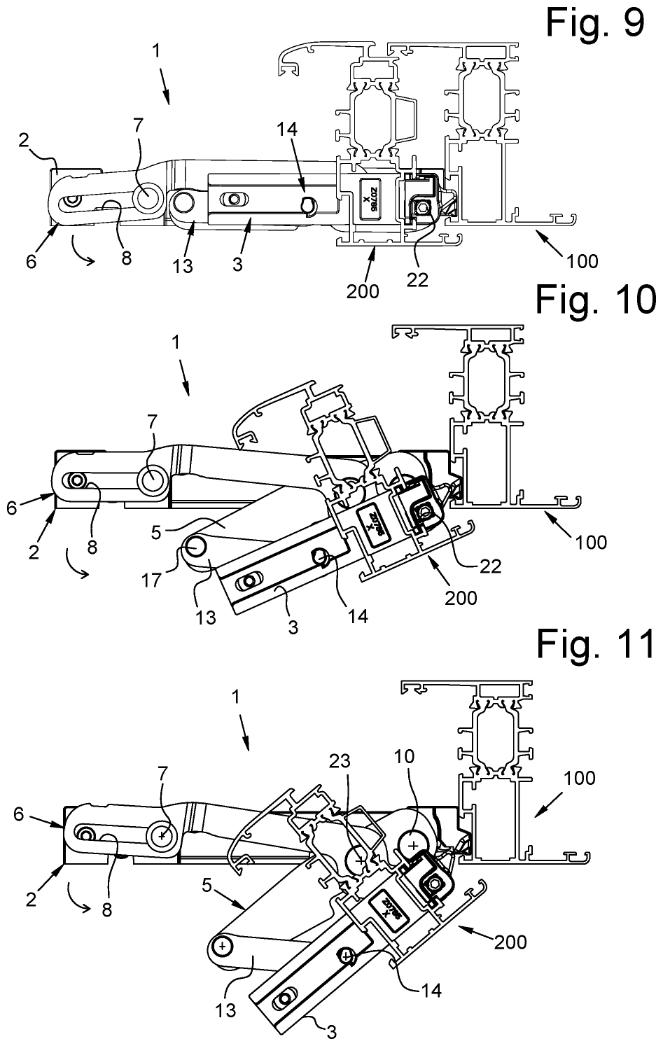

FIGS. 9 to 14 show in plan view from above the hinge system according to the present invention mounted on profiles of a fixed frame and of a movable leaf, partially depicted in section, in different successive opening positions;

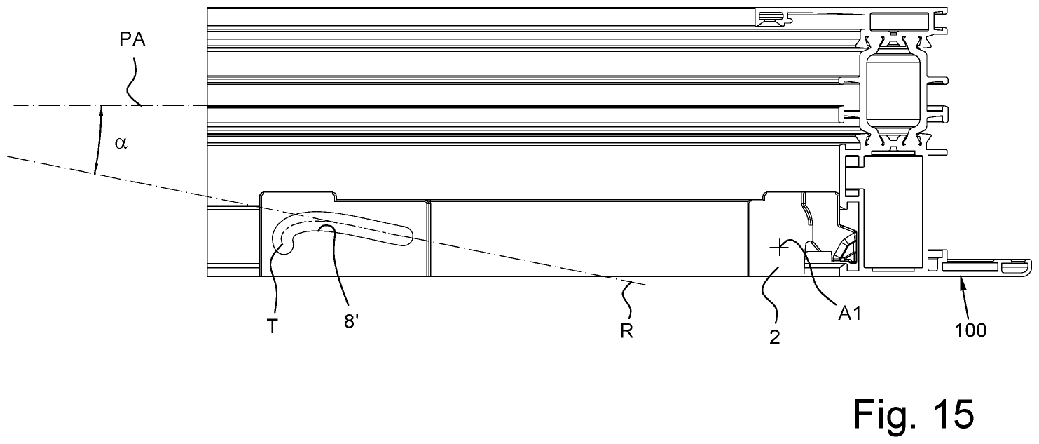

FIG. 15 schematically shows a detail (i.e. the first body) of the hidden hinge system according to the present invention in a possible alternative embodiment;

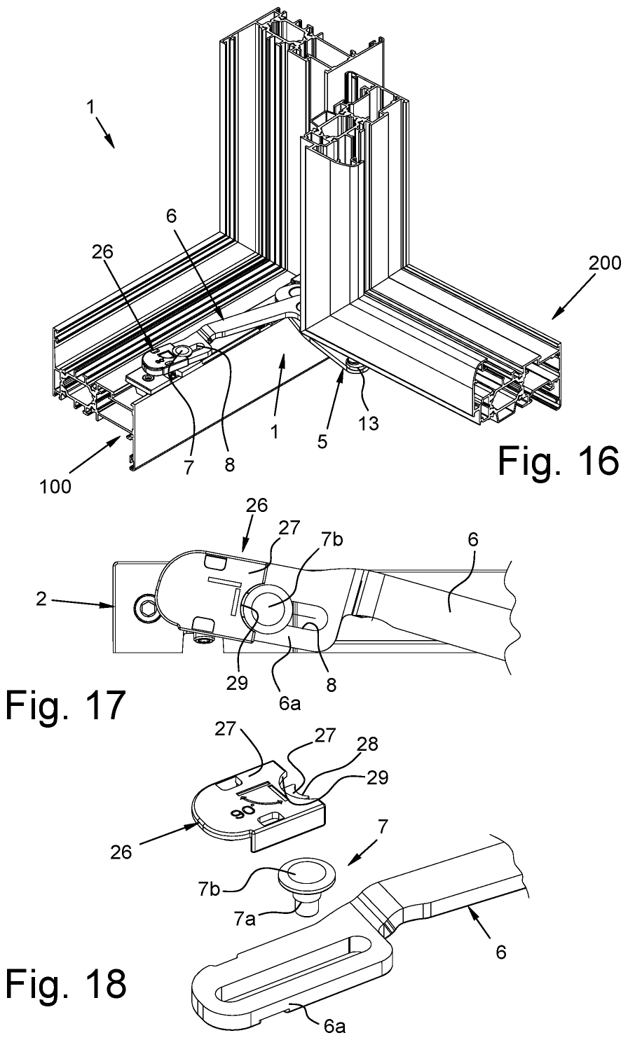

FIG. 16 is similar to FIG. 2, but with a mounted limiter of the degree of opening of the hinge system according to the present invention;

FIGS. 17 and 18 show, in an enlarged scale, respectively in plan and exploded view, the detail consisting of the limiter of FIG. 16;

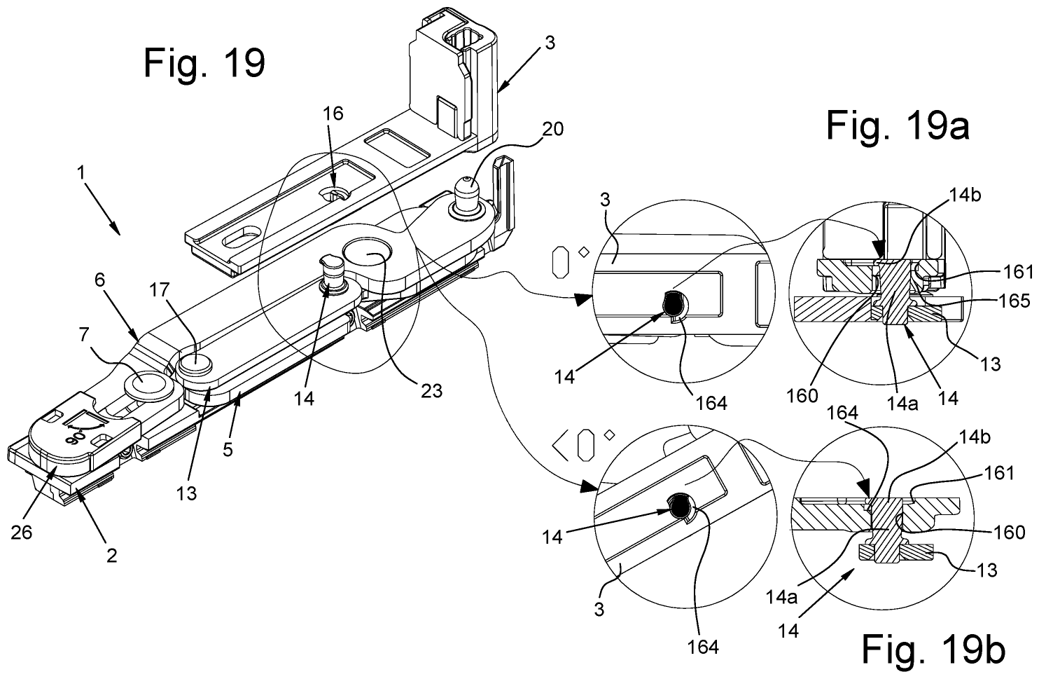

FIG. 19 shows the hidden hinge system according to the present invention in the closing position with the second body disassembled;

FIGS. 19A and 19B show on an enlarged scale a detail of FIG. 19 with the second body assembled and in two different positions, in the closing position and in an open position of the hinge system, respectively;

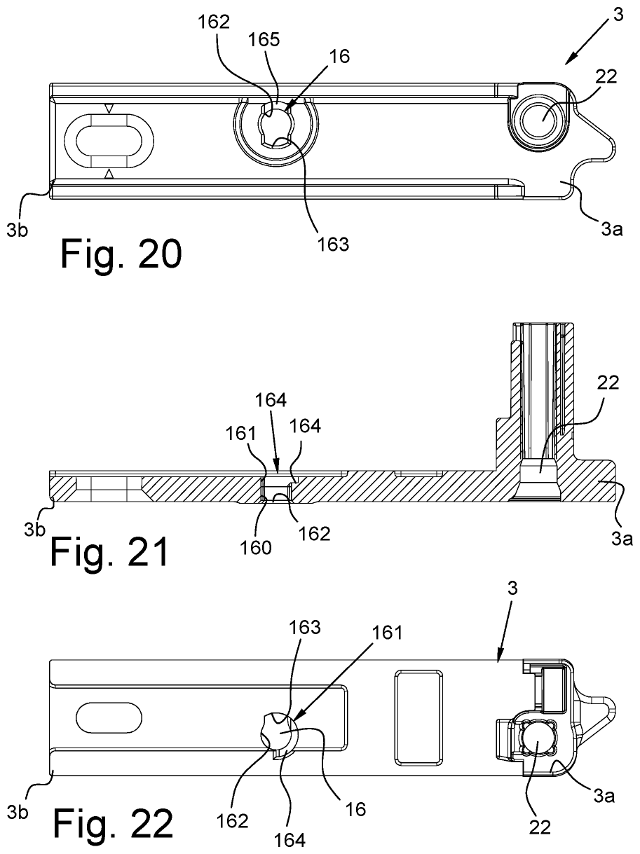

FIGS. 20, 21 and 22 are views respectively in a plan view from below, in longitudinal section and in plan view from above of the second body of the hinge system according to the present invention.

With reference to the accompanying figures, a hidden hinge system for doors or windows has been indicated as a whole with 1.

The hinge system 1 is called “hidden” since, as is evident from the accompanying figures, when the door or window is mounted, it is not visible from the outside of the door or window when it is closed, while it is only partially visible from the outside of the door or window when it is open.

The hinge system 1 is applicable to doors or windows with swing opening or tilt-and-turn opening.

The hinge system 1 is applicable to a door or window comprising a fixed frame 100 and a movable leaf 200, which are schematically and partially represented, by way of example only, in some of the accompanying figures.

Both the fixed frame 100 and the movable leaf 200 are formed by profiles 101, 201 each having at least one perimeter channel 102, 202, respectively realized on the inner perimeter of the frame 100 and on the outer perimeter of the leaf 200, in which the hinge system 1 is received.

The fixed frame 100 defines and delimits an opening that is closed by the movable leaf 200. In the following, reference will be made to the “plane of the opening”, by which expression it is meant a plane, generally vertical, on which the opening or gap delimited by the fixed frame 100 extends and schematically indicated by the trace PA shown in FIGS. 1-4. The plane of the opening PA is parallel with respect to the movable leaf 200 when the latter is in the closing position on the fixed frame 100. In other words, the plane of the opening PA is perpendicular to the plane defined by the bottom of the channel 102 and parallel with respect to the longitudinal development of the channel 102 itself.

The accompanying figures show a movable leaf 200 mounted on the fixed frame 100 rotatably about a vertical axis by means of the hinge system 1; in the specific case by means of a pair of hinge systems 1, one in correspondence of the lower corner of the movable leaf 200 and one in correspondence of the upper corner thereof and not represented, being similar to the first.

In the following, therefore, only the hinge system 1 connecting the lower corner of the movable leaf 200 to the fixed frame 100 will be described, similar hinge system 1 being able to be provided to connect the upper corner of the movable leaf 200 to the fixed frame 100.

The hinge system 1 according to the present invention is adapted to allow an opening angle between the movable leaf 200 and the fixed frame 100 of a maximum amplitude of 180°.

The hinge system 1 comprises:
a first body 2 that can be fixedly connected in a perimeter channel 102 of the profile 101 of the fixed frame 100;
a second body 3 that can be fixedly connected in a perimeter channel 202 of the profile 201 of the movable leaf 200; and
a lever assembly 4 articulating each other the first body 2 and the second body 3.

The lever assembly 4 is configured to allow the movable leaf 200 to perform a roto-translational motion with respect to the fixed frame 100, moving, during the opening and closing of the door or window, with a motion component perpendicular with respect to the plane of the opening PA.

The lever assembly 4 comprises a first lever 5 and a second lever 6, each one of which has a first end, respectively 5a, 6a, a second end, respectively 5b, 6b, and a middle portion, respectively 5c, 6c, interposed between the respective first end and second end. The first lever 5 and the second lever 6 are both articulated at their respective opposite ends to the first body 2 and to the second body 3.

The first lever 5 and the second lever 6 are then hinged to each other in correspondence of their middle portion 5c, 6c.

The first lever 5 has:
the first end 5a rotatably articulated to the first body 2 about a first rotation axis A1 fixed with respect to the first body 2,
the second end 5b rotatably articulated to the second body 3 about a second rotation axis A2 parallel with respect to the first rotation axis A1 and fixed with respect to the second body 3.

The second lever 6 has:
the first end 6a articulated to the first body 2,
the second end 6b rotatably articulated to one end of the second body 3 about a third rotation axis A3 parallel with respect to the first rotation axis A1 and fixed with respect to the second body 3.

The first lever 5 and the second lever 6 are rotatably articulated each other in correspondence of their middle portion 5c, 6c about a fourth rotation axis A4 parallel with respect to the first rotation axis A1 and fixed with respect to them.

According to the present invention, the first end 6a of the second lever 6 is articulated to the first body 2 by means of a kinematic pair realizing a rotation and translation relative motion of the first end 6a of the second lever 6 with respect to the first body 2 respectively about a fifth rotation axis A5, parallel with respect to the first rotation axis A1, and along a trajectory T (FIG. 15) that extends towards the first rotation axis A1 and that, for at least a portion, is tangent or coincident with respect to at least one rectilinear direction in R contained a plane perpendicular with respect to the first rotation axis A1, wherein said at least one rectilinear direction R is incident with respect to the plane of the opening PA.

Generally, the plane of the opening PA is a vertical plane and the rotation axes of the lever assembly 4, including the first rotation axis A1, are vertical; the at least one rectilinear direction R therefore extends on a horizontal plane and it is incident the plane of the opening PA, that is, the rectilinear direction R is incident with respect to a vertical plane containing the opening or gap delimited by the fixed frame 100 or in any case defined by the fixed frame 100, forming with it a non-null angle α.

The at least one rectilinear direction R, therefore, does not belong and is not parallel with respect to the plane of the opening PA.

In a preferred embodiment, the kinematic pair articulating the first end 6a of the second lever 6 to the first body 2 comprises a pin 7 defining the fifth rotation axis A5 and fixed to the first body 2 in correspondence of a portion of the same distal with respect to the first rotation axis A1 and slidably inserted along a slot 8 realized in the first end 6a of the second lever 6.

Said slot 8 is straight and extends along the longitudinal extension of the second lever 6.

The pin 7 comprises a stem 7a that is slidably inserted into the slot 8 and whose lower end engages in a corresponding hole 9 realised in the first body 2. The pin 7 is thus fixed to the first body 2. The upper end of the pin 7 widens into a head 7b of greater diameter than the width of the slot 8 and which slides on the first end 6a of the second lever 6.

However, alternative embodiments are not excluded, in which, the kinematic pair that articulates the first end 6a of the second lever 6 to the first body 2 comprises a pin defining the fifth rotation axis A5 and fixed to the first end 6a of the second lever 6, wherein said pin is slidable in a shaped slot 8′ realised in the first body 2 and defining the trajectory T as defined above and as schematically represented in FIG. 15.

The slot 8′ is realised in correspondence of a portion of the first body 2 distal with respect to the end of the same in correspondence of which the first rotation axis A1 is defined.

It should be noted that the trajectory T comprises an arcuate section defined in correspondence of the end of the first body 2 opposite to that in correspondence of which the first rotation axis A1 is defined. This arcuate section connects to a substantially straight section that extends towards the end of the first body 2 in correspondence of which the first rotation axis A1 is defined. This substantially straight section, or in any case the straight lines R tangent with respect to it, is incident with respect to the plane of the opening PA (vertical plane containing the opening or gap delimited by the fixed frame 100) forming with it a non-null angle α.

It can be noted that the first rotation axis A1 is the one which, under assembly conditions of the hinge system 1, is close to the profile defining the upright of the fixed frame 100 to which the movable leaf 200 is articulated.

The components of the hinge system 1 are described in more detail below.

The first body 2 has longitudinal development and is substantially plate-like so that it can be inserted into the perimeter channel 102 of the profile 101.

The first body 2 extends between a first end 2a and a second end 2b.

Similarly, the second body 3 has longitudinal development and is substantially plate-like so that it can be inserted into the perimeter channel 202 of the profile 201.

The second body 3 extends between a first end 3a and a second end 3b. In correspondence of the first end 3a there is a protruding body 3′ forming an angle with the second body 3.

The first ends, 2a and 3a, respectively, of the first body 2 and the second body 3 have been indicated as the first ends which, under assembly conditions, are positioned in correspondence of the angle of the fixed frame 100 and of the movable leaf 200 and which, when the hinge system 1 is in the closing position, are superimposed with the lever assembly 4 interposed between them.

The first rotation axis A1 is defined by a first pin 10 which is rotatably inserted in a corresponding first through hole 11 realised in correspondence of the first end 5a of the first lever 5 and which engages in a corresponding hole 12 realised in the first body 2 in the vicinity of the first end 2a thereof. It is noted that the first pin 10 and the corresponding hole 12 in which t engages each preferably have a flattened surface that extends parallel with respect to a longitudinal edge of the first body 2.

The second end 5b of the first lever 5 is articulated to the second body 3 by means of a connecting rod 13 whose opposite ends 13a, 13b are hinged respectively to the second body 3, thus defining the second rotation axis A2, and to the second end 5b of the first lever 5, defining a sixth rotation axis A6 parallel with respect to the second rotation axis A2. The second rotation axis A2 is defined by a respective pin, referred to as second pin 14 or shaped pin. The stem of the second pin 14 engages with its lower end in a corresponding hole 15 realised at the first end 13a of the connecting rod 13 and is inserted in a corresponding through opening 16 obtained in the second body 3. The through opening 16 defines a hollow seat which, together with the stem of the second pin 14, forms a cylindrical/rotoidal kinematic pair defining precisely the second rotation axis A2 and of which it will be said below.

The second end 13b of the connecting rod 13 is hinged to the second end 5b of the first lever 5 by means of a respective pin 17 which crosses with play a through hole 18 obtained in correspondence of the second end 13b of the connecting rod 13 and whose lower end engages in a corresponding hole 19 obtained in the second end 5b of the first lever 5.

The second end 6b of the second lever 6 supports a third pin 20 defining the third rotation axis A3.

The third pin 20 has the lower end engaged in a corresponding hole 21 obtained in the second end 6b of the second lever 6; it is therefore fixed to the second lever 6.

The third pin 20 is received rotatably and with play in a cylindrical seat 22 realised in the protruding body 3′, forming an integral part of the second body 3.

It is noted that the head of the third pin 20 is hemispherical to cooperate with a corresponding cap inside the cylindrical seat 22 in order to allow the inclination of the second body 3 with respect to the second lever 6 with respect to the plane of the opening PA to perform assembly/disassembly operations of the fixture and/or to allow the tilt opening of the movable leaf 200.

The first lever 5 and the second lever 6 are hinged in correspondence of their respective middle portion 5c, 6c by means of a fourth pin 23 defining the fourth rotation axis A4.

It can be noted that the arm of the first lever 5 extending between the first end 5a of the same and the fourth rotation axis A4 (fulcrum) is smaller than the arm of the same extending from said fourth rotation axis A4 to the second end 5b of the same.

Similarly, the arm of the second lever 6 extending between the first end 6a of the same and the fourth rotation axis A4 (fulcrum) is grater than the arm of the same extending from said fourth rotation axis A4 to the second end 6b of the same.

The fourth pin 23 has a stem that crosses with play a corresponding through hole 24 obtained in the second lever 6 and that engages with its lower end in a hole 25 obtained in the first lever 5.

According to a further aspect of the present invention, the hinge system 1 further comprises a limiter 26 of the amplitude of the opening angle of the movable leaf 200 with respect to the fixed frame 100.

The limiter 26 comprises a body, preferably plate-like, which can be engaged on the first end 6a of the second lever 6 or on the first body 2 in the vicinity of the second end 2b of the same and which is provided with a portion 27 that can be superimposed or inserted in the slot 8, 8′ reducing the length useful for the sliding of the pin 7 along it.

The limiter 26 can be removably coupled to the second lever 6 or to the first body 2 for example with a snap coupling.

The portion 27 of the body of the limiter 26 has at least one shaped stop surface defining an end-stroke against which a corresponding portion of the pin 7 rests at the end of its sliding relative to the slot 8, 8′. In the case depicted, the portion 27 has a first stop surface 28 against which the stem 7a of the pin 7 can be abutted and a second stop surface 29 against which the head 7b of the pin 7 can be abutted, the first stop surface 28 being lowered with respect to the second stop surface 29 so as to be accommodated in the slot 8, 8′.

It should be specified that in the accompanying figures the limiter 26 is represented to reduce the maximum opening angle of the movable leaf 200 with respect to the fixed frame 100 from 180° to 90°. As it is immediately understandable to the person skilled in the art, the limiter 26 is configurable to reduce the maximum opening angle of the movable leaf 200 with respect to the fixed frame 100 even to values other than 90°, for example at 110° or other, for example by varying the extension of the portion 27.

According to a further aspect of the present invention, moreover, the coupling between the second pin 14 (or shaped pin) and the hollow seat defined by the through opening 16 to define the second rotation axis A2 is structured to realize a cylindrical pair with a defined radial clearance, when the hinge system 1 is in the closing position of the movable leaf 200 on the fixed frame 100, and a rotoidal pair, when the hinge system 1 is in any opening position of the movable leaf 200 with respect to the fixed frame 100 following the roto-translational motion action of the first with respect to the second generated by the hinge system 1 itself.

As it will become clearer below, such a coupling ensures that the second body 3 can be inclined with respect to the first lever 5 and/or to the connecting rod 13—and thus the movable leaf 200 with respect to the fixed frame 100—when the hinge system 1 is in the closing position. This facilitates the operations of assembly and disassembly of the movable leaf 200 on the fixed frame 100—which, as described below, can take place by inclining the movable leaf 200 with respect to the fixed frame 100 and by inserting the second pin 14 in the hollow seat defined by the through opening 16 and the third pin 20 in the respective cylindrical seat 22—and/or make it possible to incline the movable leaf 200 with respect to the fixed frame 100 for a tilt opening of the door or window, if provided. At the same time, such a coupling ensures that, in any “swing” opening position of the movable leaf 200 with respect to the fixed frame 100, the second body 3 is stably anchored to the first lever 5 and/or to the connecting rod 13, eliminating risks of lifting and detachment of the movable leaf 200 from the frame 100.

In greater detail, it should be specified that the expression “cylindrical pair” means a kinematic pair in which in addition to the possibility of a relative rotary motion of the two cylindrical elements coaxial with each other forming it (rotary motion that in the case in question occurs for an angle less than) 360°, it is also possible a relative axial sliding of the one with respect to the other (a sliding that in the specific case occurs in the direction of detachment by lifting the second body 3 from the first lever 5 or from the connecting rod 13). On the contrary, “rotoidal pair” means a kinematic pair in which between the two cylindrical elements coaxial with each other forming it there is only the possibility of relative rotary motion (which in the present case occurs for an angle of less than) 360°, having prevented the relative axial sliding of the one with respect to the other.

In the present case:
when the hinge system 1 is in the closing position of the movable leaf 200 on the fixed frame 100, the cylindrical pair defined by the coupling between the second pin 14 and the hollow seat defined by the through opening 16 is adapted to allow the relative axial sliding between them in the direction of detachment of the second body 3 from the first lever 5 or from the connecting rod 13,
when the hinge system 1 is in any opening position of the movable leaf 200 with respect to the fixed frame 100, the rotoidal pair defined by the coupling between the second pin 14 and the hollow seat defined by the through opening 16 cancels this relative axial sliding of the second pin 14 with respect to the hollow seat defined by the through opening 16.

As it is immediately understandable to the person skilled in the art, such a coupling is obtained by shaping the second pin 14 and the respective hollow seat so that the one is rotatably accommodated in the second, wherein the second pin 14 and the respective hollow seat have respective mutually cooperating shaped elements to achieve a constraint through obstacle to the relative axial sliding between the second pin 14 and the respective hollow seat and interacting with each other only following a relative rotation between the second pin 14 and the respective hollow seat themselves.

With particular reference to FIGS. 19 to 22, the hollow seat comprises a first longitudinal section 160 and a second longitudinal section 161.

The first longitudinal section 160 opens with its lower end into the lower face of the second body 3, i.e. of the face of the same which is facing the first lever 5 and/or the connecting rod 13.

The second longitudinal section 161 opens with its upper end into the upper face of the second body 3, i.e. of the face of the same which, in assembly conditions, is facing the bottom of the perimeter channel 202.

The first longitudinal section 160 and the second longitudinal section 161 follow one another along the longitudinal axis of the through opening 16 and which coincides with the second rotation axis A2.

In correspondence of the first longitudinal section 160, the cross section of the hollow seat comprises a circular portion 162 extending into a radial protuberance 163 whose end is delimited by an arc of circumference concentric thereto, the circumference delimiting the end of the protuberance 163 being thus concentric to the circumference delimiting the circular portion 162 and having a greater diameter than it.

In correspondence of the second longitudinal portion 161, the cross section of the hollow seat widens starting from the radial protuberance 163 for at least a portion of the circular portion 162 along an arc of the circumference delimiting the end of the protuberance 163.

A support step 164 is thus defined in correspondence of the cross section of passage between the first longitudinal section 160 and the second longitudinal section 161.

The second pin 14 consists of a shaped pin comprising a stem 14a which at one end is engaged in the hole 15 obtained in the first lever 5 or, as shown in the figures, in the connecting rod 13 and which at the opposite end widens into a head 14b.

The head 14b has a shape copying that of the cross section of the hollow seat in correspondence of the first longitudinal section 160 of the same.

When the hinge system 1 is in the closing position of the movable leaf 200 on the fixed frame 100, the head 14b is housed with play in the second longitudinal section 161 aligned with the copying cross section of the first longitudinal section 160, thus realising a cylindrical pair, being allowed both the relative axial sliding of the second pin 14 with respect to the hollow seat, and the relative rotation between them.

When the hinge system 1 is in any opening position of the movable leaf 200 with respect to the fixed frame 100, the head 14b is superimposed at least in part with the support step 164, forming with it a constraint through obstacle that cancels the relative axial sliding between the second pin 14 and the hollow seat, in particular in the direction of detachment of the second body 3 from the first lever 5 and/or from the connecting rod 13, thus realising a rotoidal pair with only the possibility of relative rotation between the second pin 14 and the hollow seat.

Advantageously, the hollow seat has a portion of its inner side surface 165 that is flared to allow the inclination of the second body 3 with respect to the first lever 5 and/or to the connecting rod 13.

Said flared portion 165 is obtained at the lower end of the first longitudinal section 160 in a position diametrically opposite with respect to the radial protuberance 163.

It should be specified that the coupling between the second pin 14 and the hollow seat defined by the through opening 16 as described above and as represented in the accompanying figures are adopted in particular on hinge systems 1 forming the lower hinge that articulates the movable leaf 200 to the fixed frame 100, that is the hinge mounted in correspondence of the lower corner of the same.

It should also be specified that this coupling can also be adopted in hidden hinge systems other than that shown in the accompanying figures for the methods of articulation of the first lever and of the second lever to the first body and to the second body.

The hinge system 1 is completed by members for fixing the first body 2 and the second body 3 respectively to the perimeter channel 102 and to the perimeter channel 202 and members for adjusting the position of the first body 2 and of the second body 3 with respect to the perimeter channel 102 and to the perimeter channel 202, which are per se known and for this reason not described in detail.

The accompanying figures show for example threaded grub screws 30 that are inserted in corresponding threaded holes 31 with inclined axis obtained in the first body 2 and adapted to fix the latter in the perimeter channel 102, as well as cams 32 adapted to cancel any coupling clearances between the first body 2 and the perimeter channel 102.

The second body 3 is instead fixed to the profile 201 with screws 33 and threaded members 34.

The operation of the hinge system according to the present t invention is immediately understandable to a person skilled in the art in the light of the above description and the accompanying figures.

The assembly of the hinge system 1, in particular of a hinge system 1 forming the lower hinge, provides for:
anchoring the assembly formed by the first body 2 and by the lever assembly 4 to the profile 101 of the fixed frame forming the lower cross member of the same,
anchoring the second body 3 to the profile 201 of the movable leaf forming the lower cross member of the same,
by keeping the hinge system 1, or rather its assembly as defined above, in the closing position, facing the movable leaf 200 to the opening defined by the fixed frame 100, keeping it inclined with respect to the plane of the opening PA;
superimposing the profile 201 with the second body 3 anchored thereto to the profile 101 with the hinge system assembly 1 anchored thereto so that the second pin 14 fits into the through opening 16 and the third pin 20 fits into the corresponding cylindrical seat 22;
anchoring the remaining components of the hardware that are supplied with the fixture, in particular the arms that retain the upper cross member of the movable leaf 200 to the fixed frame 100 (not described or depicted because they are known to the person skilled in the art).

It is evident that, by keeping the hinge system 1 in the closing position, the coupling existing between the second pin 14 and the hollow seat defined by the through opening 16 (i.e. cylindrical pair with radial clearance), together with the coupling between the third pin 20 and the respective cylindrical seat 22, allows the movable leaf 200 to be inclined even when it is mounted and anchored on the fixed frame 100 so as to be able to open it tilted if required.

In any case, as soon as the movable leaf 200 is opened (with swing opening) with a rota-translation motion action made possible by the hinge system 1, the relative rotation of the second body 3 with respect to the first lever 5 and/or to the connecting rod 13 cancels the possibility of relative sliding of the second pin 14 with respect to the hollow seat defined by the through opening 16, ensuring the movable leaf 200 to the fixed frame 100 against the risks of detachment. This cancellation is made possible by the rotoidal coupling pair that is generated between the second pin 14 and the hollow seat defined by the through opening 16 following the constraint through obstacle that is created between the head 14b of the first one and the support step 164 of the second one. The operation of the hinge system 1 is clearly shown in the accompanying figures.

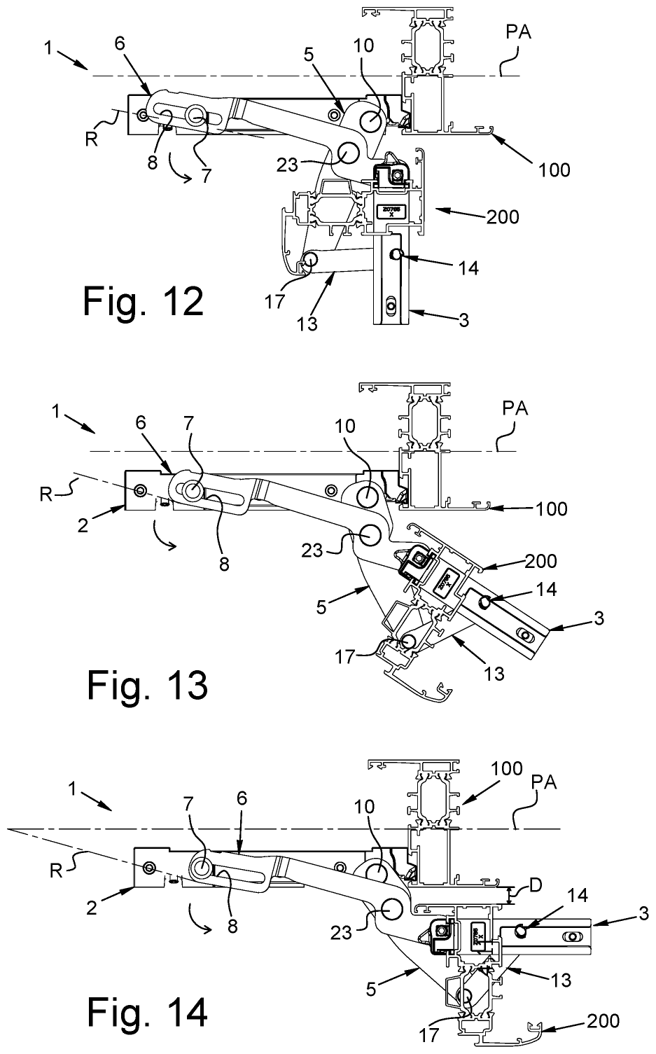

With particular reference to FIGS. 9 to 14, it is noted that during the (swing) opening of the movable leaf 200 the first end 6a of the second lever 6 first performs a rotary motion (FIGS. 9-11) with respect to the pin 7, then a roto-translation motion and finally a translation motion whose trajectory is tangent or coincident with a straight direction R that lies on a horizontal plane and that is incident with respect to the plane of the opening PA (FIGS. 12-14).

Such a movement of the second lever 6 makes it possible to move the second body 3 and therewith the movable leaf 200 outwards away from the opening delimited by the fixed frame 100, thus leaving it completely free already starting from an opening angle of 90° (FIG. 12) until reaching a maximum opening angle of 180° (FIG. 14).

Such a movement of the second lever 6 allows the movable leaf 200 to be opened keeping it detached from the fixed frame 100 by a distance D greater than a desired value, preferably equal to or greater than 1 cm.

This allows, not only to facilitate the assembly and disassembly operations and the opening and closing operations of the same without risks for a user, but also to be able to have between the fixed frame 100 and the movable leaf 200 additional support systems that allow increasing the load-bearing capacity of the hinge system 1.

FIG. 2 and FIG. 3A show such an additional support system consisting of a tip 40 that engages in a support 41 fixed to the fixed frame 100 and in a similar support 42 fixed to the movable leaf 200 and that can be adopted up to opening angles of the movable leaf 200 equal to 140°.

If it is necessary, for example for reasons of overall space dictated by the conformation of the walls, to limit the opening angle of the movable leaf 200 to a value less than 180°, it is sufficient to apply a suitably shaped/sized limiter 26 on the hinge system 1.

It should be noted that a hinge system such as the one object of the present invention, which allows a maximum opening angle of 180°, facilitates the operations of production and assembly of the fixture by the window and door manufacturer who can then, if necessary, limit the opening angle to a desired lower value (for example 90°, 110° or) 140° simply by applying a limiter 26.

It has been observed in practice that the hinge system according to the present invention makes it possible to achieve the set objectives.

The hinge system according to the present invention, in fact, allows to reach a maximum opening angle equal to 180° without the movable leaf obstructing the opening delimited by the fixed frame; when the hinge system is at the maximum opening degree (180°), and also before, the movable leaf lies outside the gap delimited by the fixed frame.

The hinge system according to the present invention also makes it possible to reach a maximum opening angle equal to 180° without the movable leaf, when fully open, being close to the fixed frame, keeping it detached from it by a desired distance D which, among other things, allows additional hidden safety systems to be adopted.

The hinge system according to the present invention also makes it possible to adjust the maximum opening angle of the movable leaf in a simple and quick way and in total safety.

The hinge system according to the present invention also makes it possible to facilitate the operations of assembly and disassembly of the movable leaf, while guaranteeing a stable support of the same in open conditions, ensuring it against the risks of detachment.

The conceived hidden hinge system is susceptible to numerous modifications and variations, all falling within the scope of the inventive concept; moreover, all the details can be replaced by technically equivalent elements. In practice, the materials used, as well as their dimensions, can be of any type according to the technical requirements.

1. Hidden hinge system (1) for doors or windows comprising a fixed frame (100) defining an opening and a movable leaf (200) closing said opening, each one of which is made up of profiles (101, 201) having at least a perimeter channel (102, 202), wherein said hinge system comprises:
a first body (2) that can be fixedly connected in a perimeter channel (102) of a profile (101) of said fixed frame (100);
a second body (3) that can be fixedly connected in a perimeter channel (202) of a profile (201) of said movable leaf (200); and
a lever assembly (4) articulating each other said first body (2) and said second body (3);
wherein said lever assembly (4) comprises:
a first lever (5) with a first end (5a) rotatably articulated to said first body (2) about a first rotation axis (A1) fixed with respect to said first body (2), a second end (5b) rotatably articulated to said second body (3) about a second rotation axis (A2) parallel with respect to said first rotation axis (A1) and fixed with respect to said second body (3), and a middle portion (5c) interposed between said first end (5a) and said second end (5b),
a second lever (6) having a first end (6a) articulated to said first body (2), a second end (6b) rotatably articulated to an end of said second body (3) about a third rotation axis (A3) parallel with respect to said first rotation axis (A1) and a middle portion (6c) interposed between said first end (6a) and said second end (6b),
wherein said first lever (5) and said second lever (6) are rotatably articulated each other in correspondence of their middle portion (5c, 6c) about a fourth rotation axis (A4) parallel with respect to said first rotation axis (A1),
characterised in that
said first end (6a) of said second lever (6) is articulated to said first body (2) by a kinematic pair (7, 8) realizing a rotation and translation relative motion of said first end (6a) of said second lever (6) with respect to said first body (2) respectively about a fifth rotation axis (A5) parallel with respect to said first rotation axis (A1) and along a trajectory (T) that extends towards said first rotation axis (A1) and that, for at least a portion, is tangent or coincident with respect to at least one rectilinear direction (R) contained in a plane perpendicular with respect to said first rotation axis (A1), wherein said at least one rectilinear direction (R) is incident with respect to the plane defined by said opening (PA).

2. Hinge system (1) according to claim 1, characterised in that said kinematic pair provides a pin (7) defining said fifth rotation axis (A5) and fixed to said first body (2) in correspondence of a portion of the same distal with respect to said first rotation axis (A1) and slidably inserted along a slot (8) realized in said first end (6a) of said second lever (6).

3. Hinge system (1) according to claim 2, characterized in that said slot (8) is straight and extends along the longitudinal extension of said second lever (6).

4. Hinge system (1) according to claim 1, characterized in that said kinematic pair comprises a pin defining said fifth rotation axis (A5) and which is fixed to said first end (6a) of said second lever (6), wherein said pin slides in a shaped slot (8′) realised in said first body (2) and defining said trajectory (T).

5. Hinge system (1) according to claim 1, characterized in that said second end (5b) of said first lever (5) is articulated to said second body (3) by means of a connecting rod (13) whose opposite ends (13a, 13b) are hinged respectively to said second body (3), defining said second rotation axis (A2), and to said second end (5b) of said first lever (5), defining a sixth rotation axis (A6) parallel with respect to said second rotation axis (A2).

6. Hinge system (1) according to claim 1, characterized in that said third rotation axis (A3) is fixed with respect to said second body (3).

7. Hinge system (1) according to claim 2, characterized in that it comprises a limiter (26) of the opening angle of said movable leaf (200) with respect to said fixed frame (100), wherein said limiter (26) comprises a body which can be engaged on said first end (6a) of said second lever (6) or on said first body (2) and which is provided with a portion (27) that can be superimposed or inserted in said slot (8, 8′) reducing its useful length for the sliding of said pin (7).

8. Hinge system (1) according to claim 7, characterized that said portion (27) of the body of said limiter (26) comprises at least one shaped stop surface (28, 29) defining a limit against which a corresponding portion of said pin (7) rests at the end of its sliding motion relative to said slot (8, 8′).

9. Hinge system (1) according to claim 1, characterized in that said second rotation axis (A2) is defined by a shaped pin (14) fixed to said second end (5b) of said first lever (5) or at the end of a connecting rod (13) articulating said second end (5b) of said first lever (5) to said second body (3) and which is inserted in a hollow seat obtained in said second body (3), wherein, when said hinge system (1) is in the closing position of said movable leaf (200) on said fixed frame (100), the coupling between said shaped pin (14) and said hollow seat defines a cylindrical pair with a radial clearance adapted to allow an inclination of said second body (3) with respect to said first lever (5) or said connecting rod (13), and wherein, when said hinge system (1) is in an opening position of said movable leaf (200) with respect to said fixed frame (100) following the roto-translational motion action of the first with respect to the second generated by said hinge system (1), the coupling between said shaped pin (14) and said hollow seat defines a rotoidal pair.

10. Hinge system (1) according to claim 9, characterized in that said coupling forming said cylindrical pair is suitable to allow the relative axial sliding of said shaped pin (14) with respect to said hollow seat along the direction of detachment of said second body (3) from said first lever (5) or said connecting rod (13), wherein said coupling forming said rotoidal pair cancels said relative axial sliding of said shaped pin (14) with respect to said hollow seat.

11. Hinge system (1) according to claim 9, characterized by the fact that said hollow seat consists of a through opening (16) obtained in said second body (3).

12. Hinge system (1) according to claim 10, characterized in that said hollow seat comprises a first longitudinal section (160) and a second longitudinal section (161), wherein the cross section of said hollow seat in correspondence with said first longitudinal section (161) comprises a circular portion (162) extending into a radial protuberance (163) delimited by an arc of circumference concentric thereto, and wherein the cross section of said hollow seat in correspondence with said second longitudinal section (161) widens starting from said radial protuberance (163) and for at least a portion of said circular portion (162) along an arc of the circumference delimiting said radial protuberance (163) so as to define a support step (164).

13. Hinge system (1) according to claim 12, characterized in that said shaped pin (14) comprises a stem (14a) which at one end is engaged in a corresponding hole (15) realised in said first lever (5) or in said connecting rod (13) and which at the opposite end widens into a head (14b) with a shape copying said cross section of said first longitudinal section (160) of said hollow seat, wherein, when said hinge system (1) is in the closing position of said movable leaf (200) on said fixed frame (100), said head (14b) is inserted with play in the second longitudinal section (161) of said hollow seat and is aligned with the copying cross section (162, 163) of said first longitudinal section (160), and wherein, when said hinge system (1) is in said opening position of said movable leaf (200) with respect to said fixed frame (100), said head (14b) is partially superimposed on said support step (164).

14. Hinge system (1) according to claim from 9, characterized in that said hollow seat has a portion (165) of its internal side surface flared to allow said inclination.

15. Hinge system (1) according to claim 13, characterized in that said flared portion (165) is obtained at the lower end of said first longitudinal section (160) in a position diametrically opposite with respect to said radial protuberance (163).
